(19) United States
(12) Patent Application Publication
(10) Pub. No.: US 2004/0219502 A1
(43) Pub. Date: Nov. 4, 2004

(54) Adaptive assessment system with scaffolded items

(76) Inventors: Sue Bechard, Denver, CO (US); Stuart R. Kahl, Rye, NH (US); Margaret Hill, Wildwood, IL (US)

Correspondence Address: MAINE & ASMUS, 100 MAIN STREET, P O BOX 3445, NASHUA, NH, 03061-3445, US

(21) Appl. No.: 10/838,060

(22) Filed: May 3, 2004

Related U.S. Application Data
(60) Provisional application No. 60/466,970, filed on May 1, 2003.

(51) Int. Cl. G09B 3/00; G09B 7/00

(52) U.S. Cl. 434/322; 434/323

(57) ABSTRACT

A system for assessment of a subject is disclosed, that system having: a first test item, at least one subject response elicited from the subject by the first test item; a reference response corresponding to the first test item, to which the at least one subject response is compared; a means for providing to the subject predetermined assistance corresponding to the first test item if the subject response to the first test item is not equal to the reference response, that assistance eliciting a further subject response; and a second test item selected as a function of the number of subject responses elicited until the subject response matches the reference response. The test items may be hierarchically related based on cognitive learning theory in a content area.

### RELATED APPLICATIONS

This application claims the benefit of U.S. Provisional Applications No. 60/466,970, filed May 1, 2003. This application is herein incorporated in its entirety by reference.

### FIELD OF THE INVENTION

The invention relates to educational assessment tools, and more particularly, to a standards-based, adaptive education assessment instrument with scaffolded items that can be used for diagnostic, formative, or summative assessment purposes

### BACKGROUND OF THE INVENTION

Assessments of the development of skills like reading and math are important tools for educators, assisting in the diagnosis of students' strengths and weaknesses so that instruction can be modified to improve student learning and achievement as well as in measuring student learning at a point in time for evaluation and accountability purposes, or on an ongoing basis as part of classroom instruction. The diagnostic features of the invention could be particularly important for students with developmental, learning, and/or other disabilities. The more precise the diagnostic assessment, the better able educators are to identify performance or learning weaknesses that must be addressed to optimize students' educational opportunities and help students reach their individual potential. Students with severe disabilities pose the greatest challenges in this regard. Accurate diagnostic tools can pinpoint areas of strength and weakness among these students and can also identify relatively minor, incremental improvements in learning and performance, improvements that are extremely important to measure, particularly for this student population.

Existing education assessments are administered either in groups or individually. Problems are associated with both methods of administration. In group administrations, complex and general instructions may be confusing, especially to young children or children with disabilities. For preschool children, the testing situation may be unfamiliar and anxiety inducing. Such confusion and anxiety undermines the validity of the results, making accurate diagnosis or performance measurement difficult. Certain popular examinations typically rank the children by percentile, rather than on mastery of particular skills geared to pre-established content standards or grade-level expectations. Regardless of the purpose of more traditional testing, the mechanism employed generally involves presenting items that students either respond to correctly or incorrectly on the first attempt. A distinguishing feature of the invention is that the design is intended to help the student respond correctly by providing incremental assistance through iterative attempts by the student to respond to the item.

Existing individually administered examinations are susceptible to either superficiality or excessive length, particularly for young children. Efficiency, without the sacrifice of efficacy, is necessary for the testing of young children, who generally lack the attention span for extensive test batteries.

Many existing assessments rarely examine specific content-related knowledge and skills of students with complex and severe disabilities. Such examinations are essential for this population of students, who may require alternate means of accessing the materials and alternative response strategies. Such children may exhibit a wide range of skills within an age group, and often possess splinter skills.

Existing computer-adaptive tests are concerned with ranking students rather than diagnosing their learning and performance strengths and weaknesses in relation to specific standards, expectations, or curriculum.

A variety of testing methods are known to those skilled in the education arts, for the assessment of skills of students from pre-kindergarten through grade 12. Examples of such tests include norm-referenced tests, Standards-based or criterion-referenced tests, and tests for children with special needs.

Adaptive test structures are known where the items are presented in order of difficulty. Students often continue taking the test as long as they answer items correctly or do not respond with a certain number of incorrect answers in succession. The underlying assumption is that the student could not correctly answer any other more difficult items once one or more incorrect answers were given. More often, the order of test questions is determined by the student's performance. The purpose of these tests is to rank students. A student's path through an adaptive test is determined by the test design and the student's performance. In some tests the item order could be bracketed, with the bracket narrowing as the level of the student's performance is approached.

Current research in math education is generally based on cognitive psychology and is constructivist in its orientation. This research underlies the National Council of Teachers of Mathematics (NCTM) Standards, which are the basis for most state frameworks. The basic tenet of these theories is that, “What is remembered is what is internalized.” When the student him/herself constructs new concepts based on what is already known, the new ideas are internalized. Emphasis is put on problem solving, both real life and mathematical, as the vehicle of teaching. The teacher provides carefully planned experiences to facilitate learning.

Most departments of education believe their frameworks to be based on the NCTM Standards, either in whole or in part. Textbooks vary across the spectrum as to how research ideas are or are not incorporated. Most give lip service at least to teaching to the NCTM Standards although some make no attempt in that direction.

Research done in the last 25 years centers on “hierarchies” of understanding in the various sub-domains of math.

What is needed, therefore, are techniques for validly and reliably assessing the skills students possess and for identifying and describing the learning pathways of non-traditional learners, that are in conformity with broadly accepted research. Such techniques should not only improve assessments designed for diagnostic purposes, but also provide richer diagnostic information from normative and summative assessments for all students. Such richer information can be beneficial to educators' efforts to improve learning for all students, as the connection between assessment and learning has been shown to be strong and increased resources are being devoted to enhancing educators skills to use assessment results for this purpose.

### SUMMARY OF THE INVENTION

One embodiment of the present invention provides a system for assessment of a subject, that system having: a first test item, at least one subject response elicited from the subject by the first test item; a reference response corresponding to the first test item, to which at least one subject response is compared; a means for providing to the subject predetermined assistance corresponding to the first test item if the subject response to the first test item is not equal to the reference response, that assistance eliciting a further subject response; and a second test item selected as a function of the number of subject responses elicited until the subject response matches the reference response.

Another embodiment of the present invention provides such a system wherein the means for providing to the subject predetermined assistance comprises a bank of clarifying information elements.

A further embodiment of the present invention provides such a system wherein the first test item is a multiple choice test item having a plurality of distracter answer choices and a correct answer choice corresponding to the reference response.

Still another embodiment of the present invention provides such a system wherein the assistance comprises elimination of at least one distracter answer choice.

A still further embodiment of the present invention provides such a system wherein the first test item comprises a base item and at least one contextual element.

Even another embodiment of the present invention provides such a system wherein the assistance comprises elimination of at least one contextual element.

An even further embodiment of the present invention provides such a system wherein the first and second test items are selected from a collection of hierarchically related test items.

Yet another embodiment of the present invention provides such a system wherein the second test item is selected as a function of a position of the first test item within the collection of hierarchically related test items.

A yet further embodiment of the present invention provides such a system wherein the second test item is selected from a plurality of test items disposed in a test item relational database, the test item relational database comprising: a content area; at least one construct, the construct being disposed within the content area; the construct have a plurality of related strands, each the strand have hierarchically related test items.

One embodiment of the present invention provides such a system wherein the hierarchically related test items are grouped in task clusters.

Another embodiment of the present invention provides such a system wherein the hierarchically related test items in the task cluster are hierarchically ordered.

A further embodiment of the present invention provides such a system wherein the hierarchically related test items in the task cluster are non-hierarchically ordered.

Still another embodiment of the present invention provides such a system wherein the test items comprise content standards and specific performance expectations.

A still further embodiment of the present invention provides such a system wherein the test items further comprise modifications resulting from review of the system.

Even another embodiment of the present invention provides such a system wherein the test items are age appropriate.

One embodiment of the present invention provides a system for assessment of a subject, the system comprising: a hierarchical test item database; an assessment administration engine, the assessment administration engine have: a test item presenter, whereby a test item is presented to the subject from the hierarchical database; a subject response comparator, whereby a subject response to the test item is compared to a reference response to the test item; an iteration counter, whereby a number of times the test item is presented the subject are recorded; an assistance manager whereby pre-determined assistance is rendered to the subject on each subsequent presentation of the test item; and a test item selector whereby a subsequent test item is selected based on the number of times the test item is presented to the subject.

Another embodiment of the present invention provides such a system wherein the assistance manager provides assistance elements selected from the group of assistance elements consisting of elimination of at least one distracter answer choice, providing scripted guidance, and eliminating at least one contextual element from the test item.

One embodiment of the present invention provides a method for the assessment of a subject, the method comprising: administering a first test item selected from a hierarchical test item database; recording a subject response from the subject; comparing the subject response to a reference response corresponding to the first test item; in response to receiving a subject response that is not equal to the reference response, administering a scripted assistance element and representing the first test item; recording the number of subject responses to the first test item; and in response to the number of responses, selecting a second test item.

Another embodiment of the present invention provides such a system further comprising: in response to a subject response that is equal to the reference response, recording the number of subject responses to the first test item; and in response to the number of responses, selecting a second test item.

A further embodiment of the present invention provides such a system further comprising reporting a metric of performance of the subject.

Even another embodiment of the present invention provides such a system wherein the metric comprises the number of subject responses required to provide a subject response matching the reference response.

An even further embodiment of the present invention provides such a system wherein the test item is selected in response to a relationship of the first test item to a test item hierarchy.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a block diagram illustrating a test assessment item configured in accordance with one embodiment of the present invention.

FIG. 2 is a block diagram illustrating a test assessment item having plurality of extraneous contextual components and configured in accordance with one embodiment of the present invention.

FIG. 3 is a block diagram illustrating a test assessment item having multiple answer choices and configured in accordance with one embodiment of the present invention.

FIG. 4 is a block diagram illustrating a test assessment item configured in accordance with one embodiment of the present invention.

FIG. 5A is a three dimensional graph illustrating a test assessment item matrix configured in accordance with one embodiment of the present invention.

FIG. 5B is a two dimensional graph illustrating a test assessment item matrix of one strand configured in accordance with one embodiment of the present invention.

FIG. 6 is a block diagram illustrating a test assessment item matrix and selection function configured in accordance with one embodiment of the present invention.

FIG. 7 is a block diagram illustrating a test assessment item matrix configured in accordance with one embodiment of the present invention.

### DETAILED DESCRIPTION OF THE INVENTION

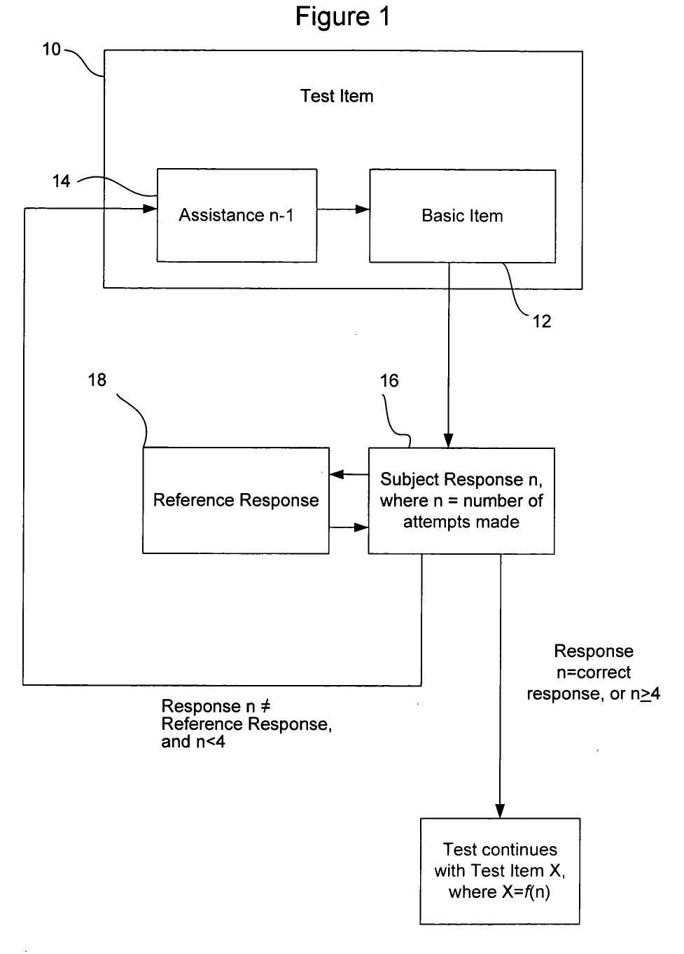

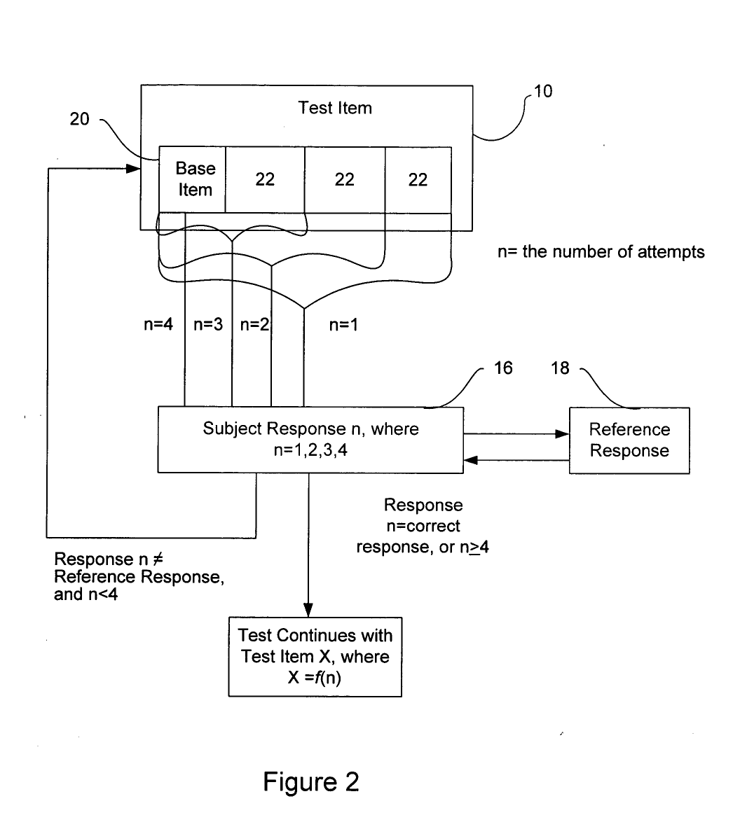

According to one embodiment of the present invention a plurality of test items 10 are provided. These test items 10, as illustrated in FIG. 1, comprise basic items 12 and standardized, scripted, or pre-determined, assistance items 14. When administered to a subject, first the basic test item 12 is presented, eliciting a response 16 from the subject. The subject response 16 is then compared to a reference response 18 associated with each test item 10. If the subject response 16 is equivalent to the reference response 18, the subject proceeds to another test item. However, if the subject response 16 is not equivalent to the reference response 18, the subject is again presented with the basic test item 12, but with the addition of a pre-established standard assistance item 14. With each iteration, pre-established incremental assistance is provided and the number of iterations required is recorded. The selection of the next test item to be presented is governed by a function of the number of iterations for the previous question. While the test items illustrated in figures represent, at most, four iterations before moving to the next text item, one skilled in the art will readily appreciate that other embodiments having more or fewer opportunities for correctly responding to the test item would also be within the scope of the present invention. Such standard assistance items 14 may be provided in a variety of forms; examples of various such embodiments are illustrated in FIGS. 2-4.

FIG. 2 illustrates an embodiment where in the initial attempt; the subject is presented with a basic test item 12 comprising a core test item 20 and a plurality of extraneous or contextual components 22. In some embodiments, this extraneous material 22 could be re-presented by contextual facts in a reading passage, not directly necessary to answer the question, or the reading passage itself in a mathematical word problem. One skilled in the art will readily appreciate that what would constitute extraneous material 22 is case specific and dependant upon the skill set tested. As described with respect to FIG. 1, a response 16 is elicited from the subject and is compared to a reference response 18. If the subject response 16 does not correspond to the reference response 18, the test item 10 is represented. In such an embodiment, re-presented test item 10 is narrowed in scope, by which is meant that one or more of the extraneous components 22 of the previous presentation are eliminated. This process is repeated until the subject response 16 corresponds with the reference response 18 or all extraneous material 22 is eliminated.

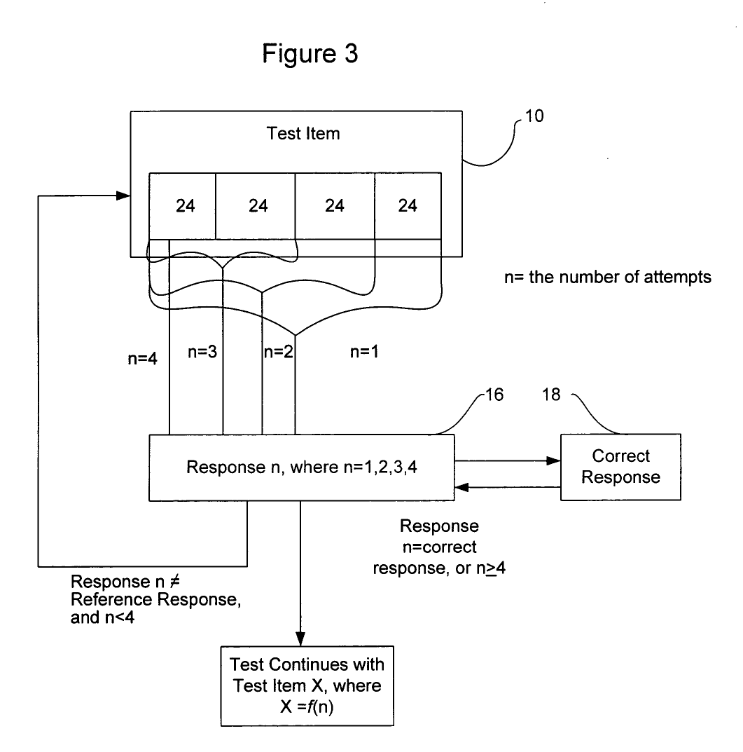

As illustrated in FIG. 3, an alternative embodiment of the present invention may provide test items 10 having a variety of answer choices 24 from which the subject selects, the incorrect choices being commonly referred to as distractors. Such a test item is commonly known as a multiple-choice or selected-response test item. In such an embodiment, with each subject response 16 that does not correspond to the reference response 18, the answer choice 24 of the incorrect subject response 16 is eliminated. As discussed above, the subject therefore has a plurality of opportunities to select the correct answer choice 24, each successive opportunity providing fewer possible choices 24 to select from, and converging to the choice 24 corresponding the reference response 18.

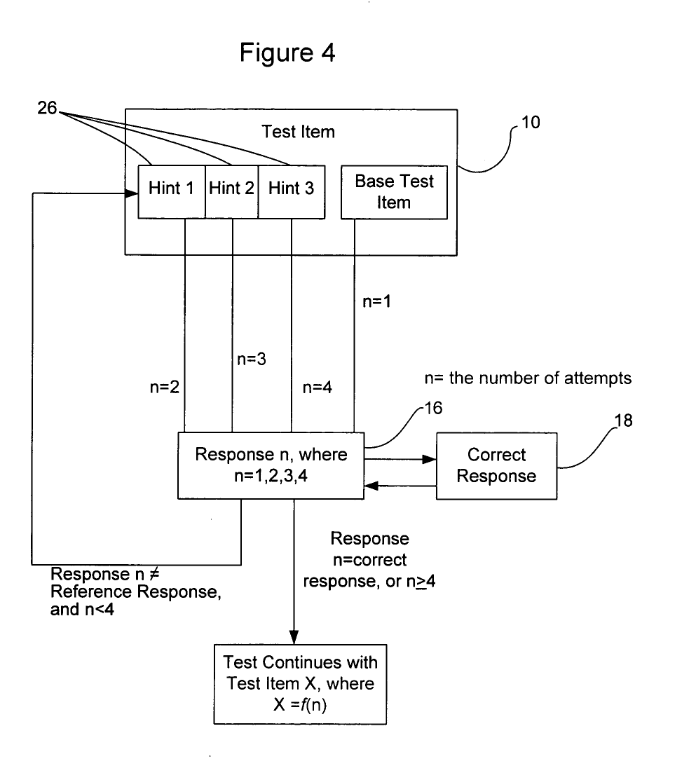

In a further alternative embodiment, illustrated in FIG. 4, a plurality of scripted hints, supplemental guides, or additional elements of information 26 are provided corresponding to each test item 10. The hints 26, as with the other forms of assistance 14 provided are presented as part of the second and each subsequent presentation of the test item 10 resulting from incorrect subject responses 16.

In each of these embodiments, the subject either responds with a subject response 16 corresponding to the reference response 18 and proceeds to the next test item, or the test item is re-presented to the subject until that appropriate response is elicited, assistance is exhausted, or a predefined number of iterations has occurred. The number of iterations, representing in the figures as “n”, is then used to determine the subject's performance on an item and in the selection of the next test item.

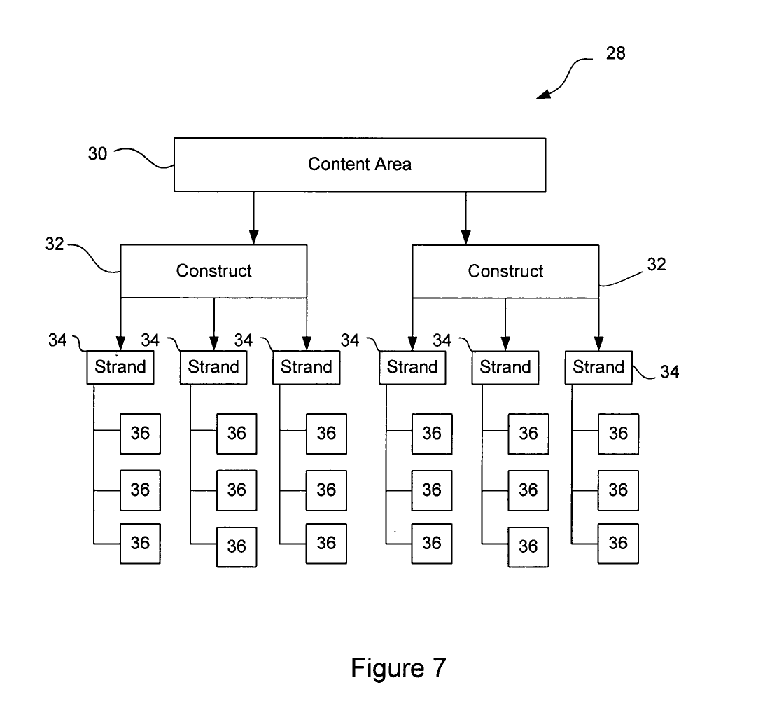

As illustrated in FIG. 7, the test items 10 may be provided in a book or computer database, and are related in a test item relationship structure 28. This structure is comprised of a content area 30. Within a content area 30 a plurality of constructs, concepts, or collections of related skill sets 32 are organized. Each construct comprises a plurality of strands 34, wherein test items 10 corresponding to a specific set of related skills is disposed. These test items 10 may, according to one embodiment, be categorized according to clusters or tasks 36 containing one or more closely related test items 10 which, within each cluster 36, can be arranged based on skill hierarchy, difficulty level, or other relevant criteria. One skilled in the art will readily appreciate that test items 10 arrayed in a plurality of hierarchical configurations within a strand 34, would likewise be within the scope of the invention.

Each strand 34 is, according to one embodiment of the present invention, a hierarchical arrangement of test items corresponding to specific skills in a skill set. The hierarchical nature of the strand 34 stems from the arrangement of the skills in the skill set according to the developmental progression from one skill to the next in the learning process. For example, a strand 34 dealing with the understanding of number concepts may have as its most basic skill, recognition and generation of whole numbers, with items ordered in incrementally increasing complexity to place values in whole numbers, and then to identifying ordinal position of objects or events. One skilled in the art will readily appreciate that such strands can be constructed in highly complicated branching hierarchies, not merely in linear progressions, such as that previously described.

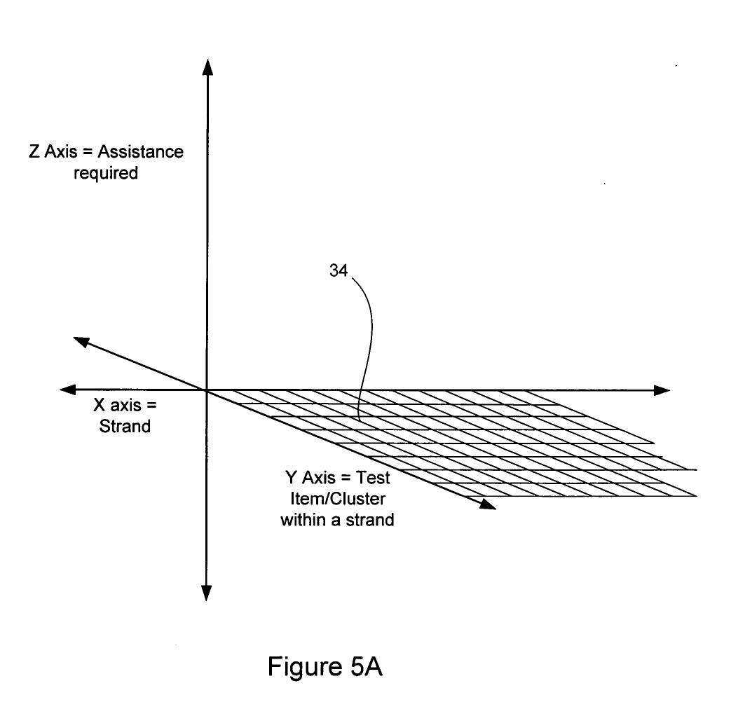

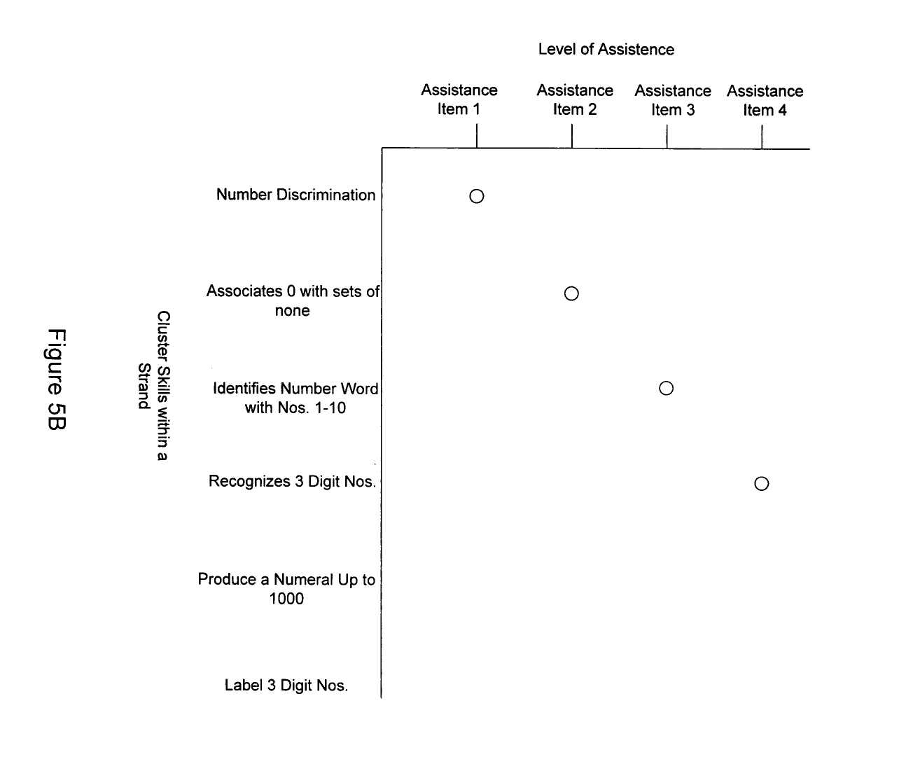

As illustrated in FIGS. 5A and 5B the relationship between test items can be expressed in terms of a three dimensional graph illustrated in FIG. 5A, with strands 34 arrayed along the X axis, test items 10 within the strand 34 arrayed along the Y axis, and the degree of assistance provided to a subject along the Z axis. FIG. 5B illustrates a two dimensional plot of a single strand of FIG. 5A. The plot illustrates the successive progression through test items relating to specific incremental developments expected in the subject. The plot of the degree of assistance rendered versus test item within a set or strand provides diagnostic information regarding the point in the strand hierarchy where the subject's competency deteriorates, facilitating remedial instructional efforts. This diagnostic approach may also be implemented in either formative or summative assessments. A formative assessment would, as one skilled in the art would appreciate from the title, be administered in the course of the learning, while a summative assessment would be more comprehensive and be administered at the conclusion of a school term or year. In either case, by designing said formative or summative assessment using said invention, the results will be more diagnostic than would otherwise be possible. A teacher concerned about a student's progress in a particular field may administer a limited, diagnostic-formative style assessment targeted to those strands the teacher observed as problematic, while alternatively, large scale diagnostic-summative assessments may be administered to one or more students to assess change over a school term or year and target areas where a class or teacher required remediation or supplementation. Similarly purely diagnostic assessments configured according to one embodiment of the present invention may be administered to students as part of a battery of tests to diagnose specific learning deficiencies in a content area.

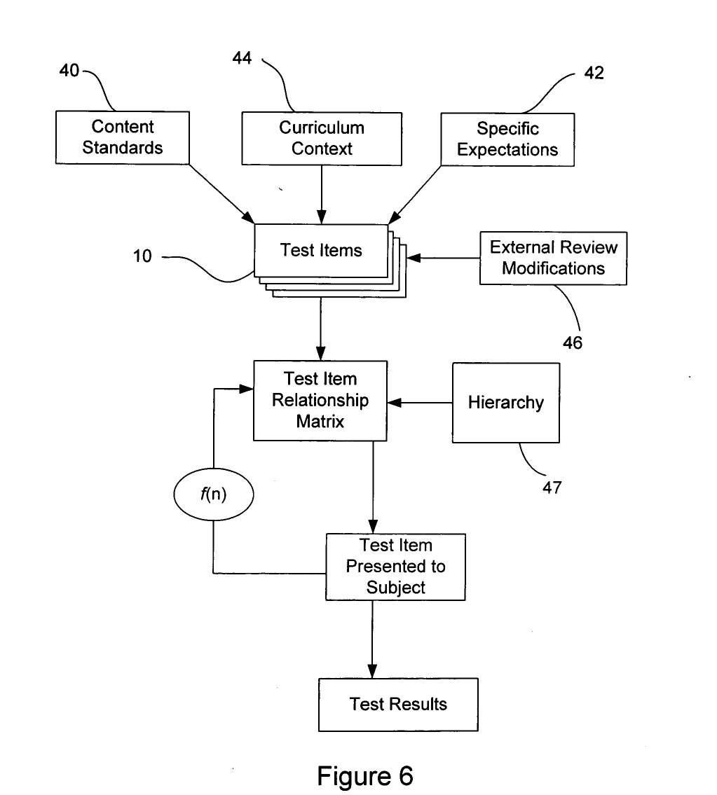

Referring to FIG. 6, test items 10 are designed using content standards 40 and specific expectations 42, and are tailored to reflect curriculum content 44 and be age appropriate to the subject. Independent and internal reviews of the test material are conducted periodically throughout the development and life of the assessment and modifications 46 resulting from the results of these reviews are incorporated into the test items 10. A hierarchy 47 within the test item relation matrix governs the relationship between the test items. This hierarchy 47 may be based or developed on concepts, cognitive theory, statistical data, or a combination thereof.

Test items 10 thus generated are integrated into the test item relationship matrix described in FIGS. 5a, 5B, and 7, In this way, the content standards 40 and specific expectations 42 are integrated in to the fabric of the test as items are written to measure student achievement of the knowledge or skills set forth in such standards or expectations. The adaptive-scaffolded nature of the assessment, however, makes each actual administration of the assessment customized to the subject. One skilled in the art will readily appreciate that the assessment may even be administered differently to the same subject at different times, depending on subject response to test items 10. The test item presented to the subject is selected from the test item database by a test item selection algorithm that is a function of the number of times “n” assistance is rendered to the subject before a correct response is provided and the content of the item 10 relative to the hierarchy. Thus, if a subject responds correctly without assistance, he or she will be presented with a different next test item than a subject answering correctly on the third or forth time. Different paths or sequences of test items are thus created, such paths may re-converge depending upon student performance, but do not necessarily converge.

One embodiment of the present invention provides an assessment system designed to identify the strengths and weaknesses of students having difficulty with the early developmental stages of mathematics (commonly covered in grades K-2) as well as to pinpoint the sources of identified weaknesses. The assessment will be, according to one embodiment, structured on the five strands and the standards of the National Council of Teachers of Mathematics (NCTM) and will be based on current research in math education.

Such an assessment program may be administered to students identified as having difficulty in mathematics on a one-to-one basis to avoid the misclassification frequent with traditional testing of primary students. The assessment is adaptive to efficiently pinpoint weaknesses and reduce testing time. The adaptive sequencing of the assessment is based upon in terms of content within discrete hierarchies, rather than simply difficulty, which is traditionally the case with adaptive assessments.

According to one embodiment, each of the items in the assessment is scaffolded, in order to provide more complete diagnostic information about student learning and performance, and to provide students with an assessment experience in which they are supported to respond to items correctly, a sharp contrast to most tests administered to students. The term scaffolding refers to a structured system of providing assistance in various forms and increasingly specific information to the student to help the student respond correctly to an item in an assessment. Results of such assessments reflect not only the correct and incorrect responses, but also the degree of independence the student demonstrated—the amount of assistance the student required—in taking the assessment.

According to one embodiment, the adaptive sequencing of the assessment items is controlled through a software program in the administrator's computer. The sequencing, or branching functionality is based on cognitive research in math education and verified through empirical data. One skilled in the art will readily appreciate that non-computerized assessments, where the administration protocol is embodied in a script or manual would also be within the scope of the present invention.

Especially when used as a diagnostic tool, testing sessions need not be long, facilitating the system's use on a regular and ongoing basis. Alternatively, when the system is used for accountability purposes, a more lengthy session might be required.

According to one embodiment, the software contains a system for tracking students' progress over time. Portions of the test can be administered at any time and the student's record updated. Note that this system will facilitate the tracking of even small improvements in student learning and performance, something that is particularly important for certain student populations, such as those with severe disabilities, and may be equally relevant to evaluating all or part of a curriculum by comparison of class wide patterns of student performance.

According to one embodiment, the assessment system may include a number of components. Among such components is an assessment system administered directly or indirectly, i.e. through the teacher/assessment administrator, using a computer on a one-to-one basis that is adaptive and scaffolded and consists of subtests that can be administered separately whenever appropriate. According to alternative embodiments, with different student populations, the assessments could be self-administered on computer.

Also included in such a system is a computer-based reporting system configured to provide student reports at the end of each testing session as well as reports based on student longitudinal progress information, to provide an entry level for future testing systems, and to provide a calibration of the achievement of students with significant disabilities relative to the general curriculum.

One embodiment of the present invention includes the ability to deliver items and obtain student responses using various modes of communications, as well as assistive technologies. According to this embodiment, a student is prompted to respond in a variety of ways. The child may respond to oral or signed instruction of the administrator and respond orally, with gestures or through assistive technology devices. Alternatively oral instruction is provided together with stimulus on laminated cards or other appropriate assistive technologies, prompting the child to respond orally, with gestures or through manipulation of responses represented on appropriate assistive technologies. In alternative embodiments and with other student populations, the assessment may be self-administered, as through the use of a computer system.

Whether a teacher or other adult administers the assessment, the administrator records responses and associated information using various methods as appropriate to the item and the information required from the assessment. Alternatively, the test may be self-administered. Examples of recordation methods include, but are not limited to, recordation of correct/incorrect when the student response does not match the exact correct response diagnosis provided by the computer program, recordation of student response, e.g., records number to which student correctly counts aloud; the answer to a computation problem, recordation of student behavior in addition to response, e.g., in simple word problems, recordation of whether students use manipulatives to solve problems, counts up, or uses addition or subtraction facts, or recordation of the level of independence displayed by the student in responding to the item.

Children may, according to one embodiment of the present invention, be permitted the use of manipulatives for some test items. For some items, manipulatives will be required, e.g., tangrams used by student to cover a figure. For other subtests, manipulatives will be available throughout the testing and used at the student's discretion, e.g., counters. Alternatively, for students with complex and severe disabilities, for all items a variety of student response options will be available.

According to one embodiment, the assessment can readily be used to create an alternate assessment with children with severe disabilities of various ages. According to this embodiment, items can be developed so as to be of appropriate interest level to students of various ages. A scaffolding system is built directly into the assessment item by item and student reports include information as to the level of scaffolding required by the student. As noted, scaffolding is a structured system of providing one or more types of assistance and increasingly specific information to the student. It is used to ascertain the level of independence a student can demonstrate in responding to an item. Generally, scaffolding begins at a level where the student is able to respond spontaneously and independently, continues with providing parallel situations or models, and can end with reducing the response options to a forced choice or directing the student to the correct response. In this manner, important diagnostic information about students, especially those with complex and severe disabilities, can be derived from examining both the level of math skills demonstrated and the level of independence the student exhibits in the demonstration of the mathematics concepts. Alternative embodiments can also be expanded to include mathematics beyond K-2 mathematics, as well as be developed for other content areas.

One embodiment of the present invention provides a tracking system. This system retains ongoing records for each student as to progress on benchmarks and independence within standards.

According to one embodiment, the assessment will be based upon and structured/organized by hierarchies structured consistently with NCTM strands. Each strand will be subdivided into standards. Standards may be similar but not identical to NCTM standards, and measured by at least one subtest. Each standard will be further divided into benchmarks. A child's work progress at each benchmark level will be tracked.

According to one embodiment, the system will be designed to measure the mathematics curriculum normally taught in pre-kindergarten through grade 2. Those skilled in the art will readily appreciate that other embodiments for other subject matter, and other age groups would be within the scope of the invention. Likewise children and adults of various ages and skill levels, from gifted to severely disabled, could be assessed with this system. The curriculum will be broken down into “hierarchies.” Within each hierarchy, benchmarks need to be sequenced so that success on a benchmark will be required in order to succeed on later benchmarks within that hierarchy. In other words, the hierarchies are defined and structured by developmental and cognitive processes associated with the acquisition of a particular skill or knowledge set. The number of hierarchies will be determined by how many such sequences are identified. The purpose of the assessment will be to pinpoint the place or places at which the student begins to experience difficulty on the different hierarchies and create a computerized record of the performance that can be readily updated to provide an ongoing record over time for educators working with the child as well as for parents. The scaffolded nature of the items and the adaptive nature of the test provides a clearer understanding of student strengths and weaknesses than would otherwise be possible from a test.

According to one embodiment, the assessment is designed for use with different classifications of students: students who are not meeting grade level expectations as identified by the teacher or by paper-and-pencil tests, non-disabled elementary students who have difficulties effecting their progress in mathematics, and students who have learning disabilities or severe disabilities that impact their learning of mathematics.

According to one embodiment, the items in the assessment will be designed to be appropriate for all students who are having difficulty with the mathematical concepts or skills regardless of age. To accomplish this, items to measure the counting hierarchy, for example, involve pictures of manipulatives such as cubes rather than pictures of cute animals as is frequent in K-2 tests. However, it would be readily apparent to one of ordinary skill in the art that the inclusion of such representations of cute animals would not render a system outside the scope of the invention. Since the manipulatives pictured are ones typically used to teach the K-2 mathematical concepts and skills, they are appropriate for young children without being insulting to older students with disabilities.

The hierarchies are based on cognitive research in mathematics learning. The hierarchies are verified by expert opinion and empirically in pilot, field, and/or operational testing.

According to one embodiment, the assessment is administered on a one-on-one basis. The testing will be adaptive, that is, the response a student gives will determine the next item in the test. The branchings in the adaptation will be based on the hierarchies determined by educational research and verified by psychometric data, rather than being based primarily on data as in traditional adaptive tests. In addition to branchings based on mathematical hierarchies, there will be branchings based on scaffolding, which is a structured system of providing pre-determined assistance and increasingly specific information to the student. Scaffolding provides a method of gathering diagnostic information both in terms of mathematical skills and levels of independence, which is particularly important for students with complex and severe disabilities. The protocols for branchings will be encoded in software for the computer used by the administrator. Many items will require pictures, graphics, or manipulatives similar to the ones the student uses regularly in the classroom. One skilled in the art will appreciate that various modes of administration and response may be built into the program to make it usable with students with various severe disabilities. On skilled in the art will likewise appreciate that mathematics has been used merely as an example of one content area, and that assessment of other subject matter than mathematics would be within the scope of the present invention, and that such other subject matter would effect the mode of administration.

Test items can take many forms. According to one embodiment, traditional test items can be used. A short-answer or longer, open-response item poses a question or prompt to which the student must respond. In some cases, the response is marked correct or incorrect. In other cases, partial credit might be awarded for incomplete, but correct, responses. As in a traditional multiple-choice (or selected-response) item, the student has a choice of answers, but may only select one.

According to one embodiment, the computer-based reporting system will provide a student report at the end of each testing session as well as reports showing longitudinal progress data on the student, an entry level for future testing systems, a calibration of the achievement of students with significant disabilities relative to the general curriculum as well as to the level of independence demonstrated.

Because the assessment is standards based rather than norm-referenced, brief testing sessions can be conducted with a student at any time to measure achievement on one or more of the hierarchies or specific standards or expectations. This is particularly helpful with young students or students with disabilities effecting attention span and is respectful of teacher/administrator scheduling.

At this time, no assessment instruments on the market have many of these features, and certainly no instrument has all of them. The combination of features will fill currently unmet needs for the various students for which it is intended.

The proposed assessment is not intended to identify students who are developmentally behind, are not meeting grade level expectations in mathematics, and/or have learning disabilities. There are a number of instruments on the market, adequate or intended to diagnosis such deficiencies. In fact, teachers can usually identify children who fit into at least one of these categories from their experiences in the classroom. For individual teachers who are well versed in the current cognitive research in mathematics education and who work in schools having good systems for reporting recent and longitudinal information to parents, this assessment may not be needed with respect to that teacher's own students. However, there are many teachers and schools with inadequate knowledge bases and reporting systems, thereby inhibiting standardized reporting and analysis on an organizational scale. A teacher, for example, may recognize that a student cannot keep up with the class with regard to solving simple word problems. By administering the brief test on the appropriate hierarchy, the teacher can determine at what point the student's lack of understanding begins. Examining the hierarchy itself will not only give information about the given student, but will also inform the teacher about an approach to teaching the concepts and skills to the entire class that is congruent with current research.

The reports generated by the system provide an ongoing record of students' progress. For teachers and parents, it is important not only to know where a student is at a given point in time, but also what and when progress has been made. The assessment system will allow such reports to be generated showing the results of all testings that have been done with the student on any given hierarchy as well as an ongoing summary report regarding which hierarchies (or subparts thereof) have been mastered and which are in progress.

As discussed above, alternate assessments that examine the specific content-related knowledge and skills of moderately or severely disabled students are almost non-existent. These students require multiple means of accessing the materials and multiple response strategies. They may exhibit a wide range of skills within an age group and often possess splinter skills. A valid assessment is needed that can effectively identify the skills they possess and ultimately describe the learning pathways of these non-traditional learners.

Appropriate assessments instruments for this population require innovative delivery and administration strategies, as well as feedback systems that enhance teachers' understanding of mathematics concepts and identify next steps for students. Particularly for this group it is critical that the structure of the system allows for ongoing, progressive assessment opportunities that build on previous information.

According to one embodiment, a scoring system based on scaffolding for students with complex disabilities provides options for responding at various levels of independence. This system enhances the diagnostic capabilities of the assessment tool. Students will often have choices of manipulatives and response modes. Items are designed to include the diversity of learners who will take the assessment.

It is anticipated that the assessments, when used with severely disabled students, will provide information that is valuable and unique. Teachers will have immediate feedback on the progress of students in learning important mathematics concepts. In addition through the authentic assessment activities they will also have models of effective instructional practices that can be incorporated into daily classroom teaching and learning.

Detailed and new information will be available on the learning of unique groups of students. Analyses of these data could lead to new understandings of the thinking skills and problem solving abilities of students for whom this information does not currently exist. The body of knowledge on cognition and learning will be enhanced by the addition of these findings. Thus, one of ordinary skill in the art will readily appreciate that this system would be not only applicable to educational testing, but to research and cognitive studies and may aid in neurological analysis.

According to one embodiment, the assessment may be administered to the subject successively, starting at the point where deterioration in performance was recorded, thereby enabling subject progress to be measured efficiently as repetition of earlier stages in the assessment is unnecessary.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A system for assessment of a subject, the system comprising:
a first test item;
at least one subject response elicited from said subject by said first test item;
a reference response corresponding to said first test item, to which said at least one subject response is compared;
means for providing to said subject predetermined assistance corresponding to said first test item if said subject response to said first test item is not equal to said reference response, said assistance eliciting a further said subject response; and
a second test item selected as a function of the number of said subject responses elicited until said subject response matches said reference response.

2. The system according to claim 1 wherein said means comprising a bank of clarifying information elements.

3. The system according to claim 1 wherein said first test item is a multiple choice test item having a plurality of distracter answer choices and a correct answer choice corresponding to said reference response.

4. The system according to claim 3 wherein said assistance comprises elimination of at least one said distracter answer choice.

5. The system according to claim 1 wherein said first test item comprises a base item and at least one contextual element.

6. The system according to claim 5 wherein said assistance comprises elimination of at least one said contextual element.

7. The system according to claim 1 wherein said first and second test items are selected from a collection of hierarchically related test items.

8. The system according to claim 7 wherein said second test item is selected as a function of a position of said first test item within said collection of hierarchically related test items.

9. The system according to claim 7 wherein said collection of hierarchically related test items is ordered according to a hierarchy selected from the group of hierarchies consisting of conceptual hierarchies, statistical hierarchies, and hybrids of the two.

10. The system according to claim 1 wherein said second test item is selected from a plurality of test items disposed in a test item relational database, said test item relational database comprising:
a content area;
at least one construct, said construct being disposed within said content area;
said construct comprising a plurality of related strands, each said strand comprising hierarchically related test items.

11. The system according to claim 10 wherein said hierarchically related test items are grouped in task clusters.

12. The system according to claim 11 wherein said hierarchically related test items in said task cluster are hierarchically ordered.

13. The system according to claim 11 wherein said hierarchically related test items in said task cluster are non-hierarchically ordered.

14. The system according to claim 1 wherein said test items comprise content standards and specific performance expectations.

15. The system according to claim 14 wherein said test items further comprise modifications resulting from review of said system.

16. The system according to claim 1 wherein said test items are age appropriate.

17. A system for assessment of a subject, the system comprising:
a hierarchical test item database;
an assessment administration engine, said assessment administration engine comprising:
a test item presenter, whereby a test item is presented to said subject from said hierarchical database;
a subject response comparator, whereby a subject response to said test item is compared to a reference response to said test item;
an iteration counter, whereby a number of times said test item is presented said subject are recorded;
an assistance manager whereby pre-determined assistance is rendered to said subject on each subsequent presentation of said test item; and
a test item selector whereby a subsequent test item is selected based on said number of times said test item is presented to said subject.

18. The system according to claim 17 wherein said assistance manager provides assistance elements selected from the group of assistance elements consisting of elimination of at least one distracter answer choice, providing scripted guidance, and eliminating at least one contextual element from said test item.

19. A method for the assessment of a subject, the method comprising:
administering a first test item selected from a hierarchical test item database;
recording a subject response from said subject;
comparing said subject response to a reference response corresponding to said first test item;
in response to receiving a subject response that is not equal to said reference response, administering a scripted assistance element and representing said first test item;
recording the number of subject responses to said first test item; and
in response to said number of responses, selecting a second test item.

20. The method according to claim 19, further comprising:
in response to a subject response that is equal to said reference response, recording the number of subject responses to said first test item; and
in response to said number of responses, selecting a second test item.

21. The method according to claim 19 further comprising reporting a metric of performance of said subject.

22. The method according to claim 21, wherein said metric comprises the number of said subject responses required to provide a subject response matching said reference response.

23. The method according to claim 19 wherein said test item is selected in response to a relationship of said first test item to a test item hierarchy.

24. The method according to claim 19 wherein said test item hierarchy is a hierarchy selected from the group of hierarchies consisting of conceptual hierarchies, statistical hierarchies, and hybrids of the two.
